(19) United States
(12) Patent Application Publication
(10) Pub. No.: US 2007/0189014 A1
(43) Pub. Date: Aug. 16, 2007

(54) Light reflecting triggering device for a paintball gun

(76) Inventor: Hsin-Cheng Yeh, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/354,808

(22) Filed: Feb. 16, 2006

(51) Int. Cl. F21V 7/00

(52) U.S. Cl. 362/341

(57) ABSTRACT

A light reflecting triggering device for a paintball gun includes a trigger and a light reflector. The light reflector has a light emission unit and a light receiving unit spaced each other. When the trigger is pressed, the trigger will extend into the light reflector and the light from the light emission unit will be reflected to the light receiving unit. The light reflector transmits a signal to trigger the paintball bullet. Each light represents one shot of the paintball bullet in a fast and precision manner.

### BACKGROUND OF THE INVENTION

1. Field of the Invention

The present invention relates to a light reflecting triggering device for a paintball gun, and more particularly to a device to keep precision measurement of the shooting and triggering.

2. Description of the Prior Art

As shown in FIG. 3, a conventional paintball gun comprises a gun body A, a trigger A1, a micro switch A2, and an electronic controller A3. The micro switch A2 has a spring plate A21. When the trigger A1 is triggered, the micro switch A2 is triggered to send a signal to the electronic controller A3 which controls the shooting of the paintball gun.

When the micro switch A2 is triggered, each time the trigger A1 is pulled, one paintball bullet is shot. The more the trigger A1 is pulled, the more bullets will be shot. Owing to the spring plate A21 is activated by the micro switch A2 to shoot, if the spring plate A21 is too loose, a single trigger my cause multiple shots, on the other hand, if the spring plate A21 is too tight, the triggering may not be sensitive and causes retarded reaction of shooting.

### SUMMARY OF THE INVENTION

It is a primary object of the present invention to provide a light reflecting triggering device for a paintball gun, which is steady in shooting and precise for continues shots.

It is another object of the present invention to provide a light reflecting triggering device for a paintball gun, which shoots one bullet with every triggering precisely.

### BRIEF DESCRIPTION OF THE DRAWINGS

FIG. 1 is a side view of the present invention;

FIG. 2 is a side view of the present invention in an operating status, and

FIG. 3 is a side cross-sectional view of the prior art.

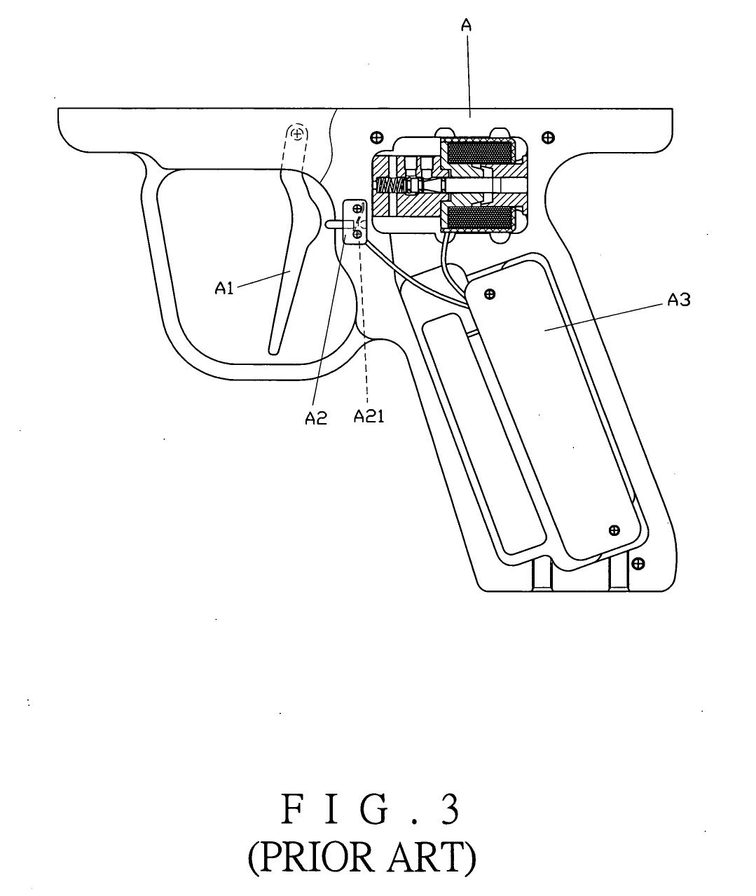

### DETAILED DESCRIPTION OF THE PREFERRED EMBODIMENT

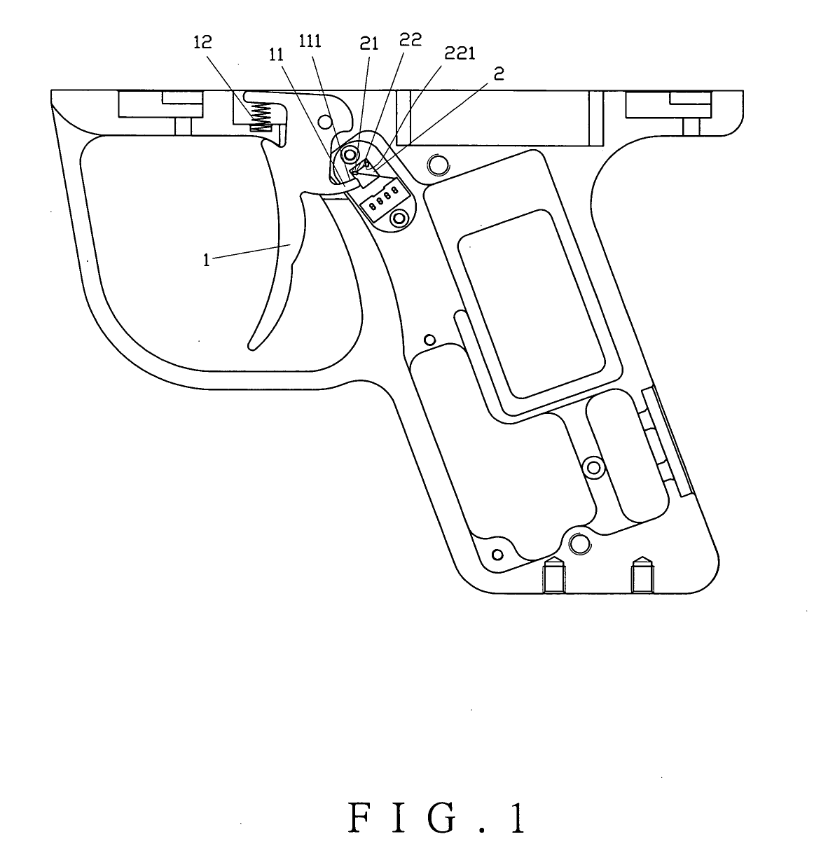

As shown in FIG. 1, the present invention comprises a trigger 1 and a light reflector 2.

The trigger 1 has an extension plate 11 and a spring 12. The extension plate 11 has a reflecting section 111.

The light reflector 2 is a device to transform light into an electronic signal and comprises a light emission unit 21 and a light receiving unit 22 spaced each other. Both of which are set in a predetermined position to reflect light and all of the parts are formed into an electronic device. The light receiving unit 22 has a light receiving surface 221 to enhance receiving of light so that the device is more precise and accurate. Further, if the location of the light emission unit 21 and the light receiving unit 22 can be measured to be more precise and more accurate, the light receiving surface 221 may be designed as a light receiving point.

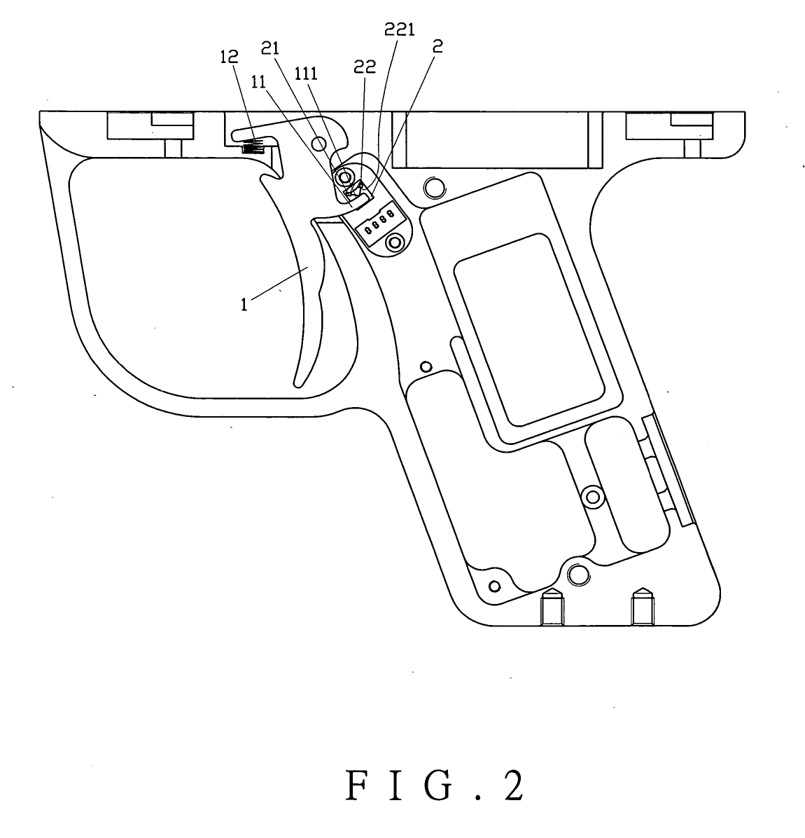

To operate the present invention, as shown in FIG. 2, when the trigger 1 is triggered, the spring 12 is pressed by the trigger 1 and the trigger 1 will extend into the light reflector 2. In this embodiment, the reflecting section 111 of the extension plate 11 will be inserted into the light reflector 2. The light from the light emission unit 21 will hit the reflecting section 111 which then reflects the light to the light receiving surface 221 of the light receiving unit 22. The light reflector 2 transmits a signal to shoot. Upon the trigger 1 is released, the spring 12 will urge the trigger 1 to restore its original position, which brings the extension plate 11 away from the light reflector 2. Thus the light receiving unit 22 will no longer receive any light, and the shooting is stopped.

Therefore, by triggering the trigger 1, the extension plate 11 will extend into the light reflector 2 and the light from the light emission unit 21 will be reflected to the light receiving surface 221 of the light receiving unit 22. The light reflector 2 transmits a signal to trigger the gun to shoot. This design makes the shooting, in particular a continuous shooting, more precise and more accurate.

What is claimed is:

1. A light reflecting triggering device for a paintball gun comprising a trigger and a light reflector, said light reflector comprising a light emission unit and a light receiving unit spaced each other, said light emission unit and said light receiving unit being located in a particular position with respect to each other, said trigger comprising a reflecting section to reflect light from said light emission unit to said light receiving unit.

2. The light reflecting triggering device for a paintball gun, as recited in claim 1, wherein said trigger comprises an extension plate, and said reflecting section is disposed on said extension plate.

3. The light reflecting triggering device for a paintball gun, as recited in claim 1, wherein said light receiving unit comprises a light receiving surface.
